(19) United States
(12) Patent Application Publication
(10) Pub. No.: US 2007/0090580 A1
(43) Pub. Date: Apr. 26, 2007

(54) ADJUSTABLE CLAMP SYSTEM

(76) Inventor: Gary FRATIANNE, Avon Lake, OH (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/551,403

(22) Filed: Oct. 20, 2006

Related U.S. Application Data
(60) Provisional application No. 60/729,572, filed on Oct. 24, 2005.

(51) Int. Cl. B25B 1/00

(52) U.S. Cl. 269/6

(57) ABSTRACT

An adjustable clamp system and method for extending the jaw opening of an adjustable clamp are presented. The adjustable clamp system includes a first slide-adjustable clamp and a second slide-adjustable clamp, with each clamp having a fixed jaw and a movable jaw. The system further comprises, for each of the slide-adjustable clamps, a rail, along which the movable jaw travels. The ends of the rails of the two adjustable clamps, relieved subsequent to the removal of the fixed jaw member, are engaged. Upon engagement of the rails, a coupling member suitably aligns and secures them, so as to maintain the joining thereof. The jaw opening of the adjustable clamp is formed by the jaw member movably attached to the first rail and the jaw member movably attached to the second rail, being substantially increased thereby.

### CROSS-REFERENCE TO RELATED APPLICATIONS

This application is based on and claims priority to provisional U.S. patent application Ser. No. 60/729,572, which was filed on Oct. 24, 2005.

### BACKGROUND OF THE INVENTION

This subject application is directed to a fastening or tightening arrangement and, more particularly, to an arrangement for clamping various materials, such as wood, metal, PVC, and the like. More particularly, this invention is directed to an adjustable clamp system and a method for extending a jaw opening of an adjustable clamp by combining two quick-release clamps into a single clamp with an extended jaw opening.

Adjustable clamps are commonly used in today's construction and home improvement industry. An adjustable clamp, such as a quick-release or slide clamp, typically employs a fixed portion, attached to an elongated rail. The remaining end of the rail is engaged by a movable portion, which is secured to the rail using a tensioned lever against a portion of the rail. However, the typical adjustable clamp is limited in size, which in turn limits the opening between the movable portion and fixed portion. This equates to a limitation on the size of the materials, such as wood, metal, PVC, and the like, for which the typical adjustable clamp is applicable, since the materials may have a width greater than that of the jaw opening of the clamp.

Thus there is a need for an adjustable clamp with an extended jaw opening.

There is also a need for a method for extending the jaw opening of an adjustable clamp.

### SUMMARY OF INVENTION

In accordance with the subject application, there is provided an adjustable clamp system with an extended jaw opening.

Further, in accordance with the subject application, there is provided a method for extending a jaw opening of an adjustable clamp.

Still further in accordance with the subject application, there is provided a method for combining two adjustable clamps into a single clamp with an extended jaw opening.

In accordance with one aspect of the subject application, there is provided an adjustable clamp system, including a first clamp member and a second clamp member. The first clamp member includes a first transition member having a first end and a second end. The first transition member also includes an opening disposed on its first end. The first clamp member further includes a first jaw member movably attached to the first transition member. The second clamp member includes a second transition member having a first end and a second end. The second transition member further includes an opening disposed on its first end. The second clamp member further includes a second jaw member movably attached to the second transition member. According to the invention, the first end of the first transition member fixedly engages the opening of the second transition member, wherein the first end of the second transition member fixedly engages the opening of the first transition member.

In a preferred embodiment, the adjustable clamp system further includes a first dowel pin disposed on the first end of the first transition member offset from the opening. The adjustable clamp also includes a second dowel pin disposed on the first end of the second transition member offset from the opening. In this embodiment, the first end of the first transition member engages the opening of the second transition member by virtue of the first dowel pin. Further, the first end of the second transition member engages the opening of the first transition member by virtue of the second dowel pin.

Preferably, the adjustable clamp system of the subject application further includes a first detent member coupled with the first jaw member and a second detent member coupled with the second jaw member. As will be appreciated by those skilled in the art, the first detent member and the second detent member are adapted each for maintaining a corresponding jaw member in a given position with respect to a corresponding transition member.

In another preferred embodiment, the adjustable clamp system further includes a coupling member adapted for securing the fixedly engaged first ends of the first and second transition members. Preferably, the coupling member is further adapted for aligning the first and second transition members. A skilled artisan will appreciate, that the coupling member is further adapted for enveloping at least partially the engaged first ends of the first and second transition members. Preferably, the coupling member includes a cylinder body.

In accordance with another aspect of the subject application, there is provided an adjustable clamp system, including a first clamp member and a second clamp member. The first clamp member includes a first transition member. The first transition member has a first end and a second end, and includes an opening disposed on its first end. The first clamp member also includes a first jaw member movably attached to the first transition member. The second clamp member includes a second transition member. The second transition member has a first end and a second end, and includes an opening disposed on its first end. The second clamp member further includes a second jaw member movably attached to the second transition member.

Further included in the adjustable clamp system is a third transition member having a first end and a second end. The third transition member includes an opening disposed on its first end, and an opening disposed on its second end. In accordance with the subject application, the first end of the first transition member fixedly engages the opening disposed on the first end of the third transition member. In addition, the first end of the second transition member fixedly engages the opening disposed on the second end of the third transition member.

In a preferred embodiment, the adjustable clamp system further includes a first dowel pin disposed on the first end of the first transition member offset from the respective opening, and a second dowel pin disposed on the first end of the second transition member offset from the respective opening. In this embodiment, the first end of the first transition member engages the opening disposed on the first end of the third transition member by virtue of the first dowel pin. The first end of the second transition member engages the opening disposed on the second end of the third transition member by virtue of the second dowel pin.

In accordance with another aspect of the subject application, there is provided a method for extending a jaw opening of an adjustable clamp. The adjustable clamp includes a first transition member having a first end and a second end, a jaw member movably attached to the first transition member, and a jaw member fixedly attached to the first end of the first transition member. The method commences by removing the fixedly attached jaw member from the first transition member. Next, a fixedly attached jaw member is removed from a second transition member. The second transition member is part to another adjustable clamp. The second transition member has a first end and a second end, wherein the other adjustable clamp further includes a jaw member movably attached to the second transition member. The fixedly attached jaw member of the other adjustable clamp is attached to the first end of the second transition member.

In accordance with the method of the subject application, a coupling member is then engaged with the first transition member. Those skilled in the art will appreciate, that the coupling member is slidable with respect to the first transition member. Next, the first end of the first transition member is fixedly engaged with the first end of the second transition member. Preferably, a dowel pin, relieved on the first end of the first transition member subsequent to the removal of the fixedly attached jaw member, is inserted into an opening, relieved on the first end of the second transition member subsequent to the removal of the fixedly attached jaw member. Also, a dowel pin, relieved on the first end of the second transition member subsequent to the removal of the fixedly attached jaw member, is inserted into an opening, relieved on the first end of the first transition member subsequent to the removal of the fixedly attached jaw member.

The fixedly engaged first ends of the first and second transition members are then secured by virtue of the coupling member. Preferably, the fixedly engaged first ends of the first and second transition members are aligned by means of the coupling member. Thus, the jaw opening of the adjustable clamp is formed by the jaw member movably attached to the first transition member and the jaw member movably attached to the second transition member.

Still other objects and aspects of the present invention will become readily apparent to those skilled in this art from the following description wherein there is shown and described a preferred embodiment of this invention, simply by way of illustration of one of the best modes suited for to carry out the invention. As it will be realized by those skilled in the art, the invention is capable of other different embodiments and its several details are capable of modifications in various obvious aspects all without departing from the scope of the present application. Accordingly, the drawings and description will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a side perspective view of separate components of the adjustable clamp system in accordance with the present invention;

FIG. 2 is a side perspective view of the first and second transition members of the adjustable clamp system in accordance with the present invention.

FIG. 3 is a side perspective view of the first and second transition members of the adjustable clamp system in an engaged position in accordance with the present invention. FIG. 4 is a side perspective view of the adjustable clamp system in accordance with the present invention;

FIG. 5 is illustrates the coupling member of the adjustable clamp system in accordance with the present invention; and

FIG. 6 illustrates the method for extending a jaw opening of an adjustable clamp in accordance with the present invention.

### DETAILED DESCRIPTION OF THE PREFERRED EMBODIMENTS

The present invention is directed to an adjustable clamp system with an extended jaw opening. More particularly, the present invention is directed to system and method for extending a jaw opening of an adjustable clamp by combining two quick-release clamps into a single clamp with an extended jaw opening.

In the preferred embodiment, as described herein, the adjustable clamp system employs a quick-release clamp, suitably adapted to include a removably secured member at the distal end of a slide rail and a movable member, slidably engaged around the slide rail and suitably equipped with a detent member, such as a tension-based braking mechanism, so as to prevent the movable member from moving unless such mechanism is in the relaxed position. However, the skilled artisan will appreciate that other types of clamps are equally capable of employing the methods described herein, without departing from the spirit of the instant invention. As will be recognized by those skilled in the art, the fixed member is removably secured using suitable dowel pins and openings corresponding thereto, suitably disposed on the fixed member and the respective end of the slide rail, as will be explained in greater detail below.

As illustrated in the attached figures, the adjustable clamp is any commercially available clamp known in the art and which includes a slide rail along which one jaw of the clamp slides to engage items between the fixed jaw and the movable jaw. It will be appreciated by those skilled in the art that as used herein, the term “fixed jaw” refers to the secured member of an adjustable clamp, which is capable of being removed by the user, whereas the term “moving jaw” refers to the movable member of the adjustable clamp. The skilled artisan will appreciate that the slide rail is representative of the transitional member of an adjustable clamp. The transitional member is suitably capable of being implemented, for example and without limitation, as a long screw, a smooth rectangular member, or any other connecting means known in the art suitably adapted for use with adjustable clamps.

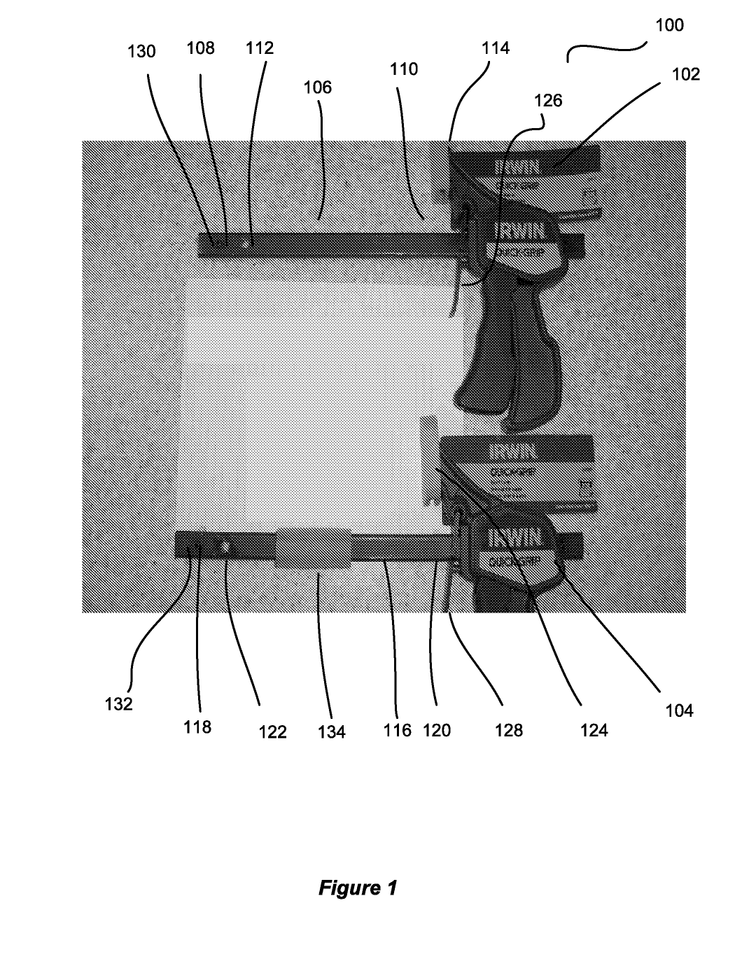

Turning now to FIG. 1, there is shown a side perspective view 100 of a first clamp member 102 and a second clamp member 104 in accordance with the present invention. The first clamp member 102 includes a first transition member 106 having a first 108 end and a second end 110. The first transition member 106 also includes an opening 112 disposed on its first end 108. The first clamp member 102 further includes a first jaw member 114 movably attached to the first transition member 106.

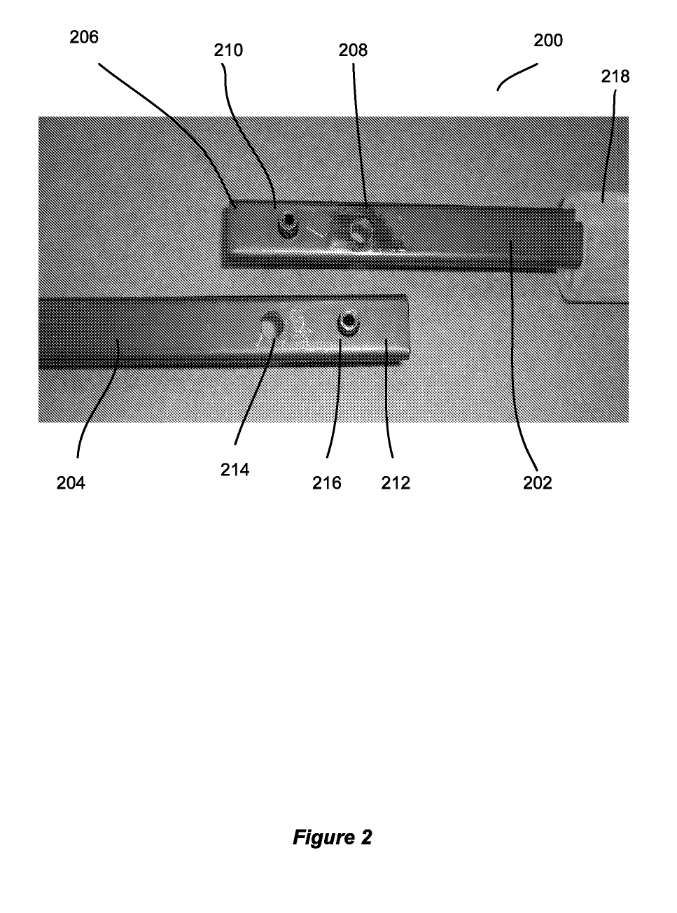

As shown in FIG. 1, the second clamp member 104 includes a second transition member 116 having a first end 118 and a second end 120. The second transition member 116 further includes an opening 122 disposed on its first end 118. The second clamp member 104 further includes a second jaw member 124 movably attached to the second transition member 116. Preferably, the adjustable clamp system of the subject application further includes a first detent member 126 coupled with the first jaw member 114 and a second detent member 128 coupled with the second jaw member 124. As will be appreciated by those skilled in the art, the first detent member 126 and the second detent member 128 are adapted each for maintaining a corresponding jaw member 114, 124 in a given position with respect to a corresponding transition member 106, 116. Also disposed on respective first ends 108, 118 of the first and second transition members 106, 116 are dowel pins 130, 132, respectively, illustrated specifically in FIG. 2.

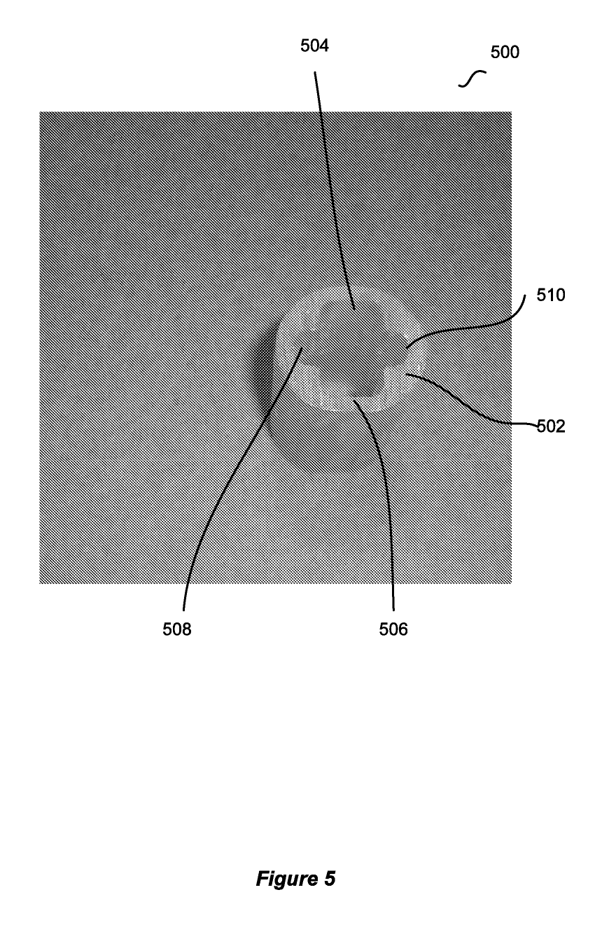

Turning now to FIG. 2, there is shown a side perspective view 200 of a first transition member 202 and of a second transition member 204 in accordance with the present invention. Disposed on the first end 206 of the first transition member 202 is an opening 208. As shown in FIG. 2, a first dowel pin 210 offset from the opening 208, is also disposed on the first end 206 of the first transition member 202. Disposed on the first end 212 of the second transition member 204 is an opening 214. A second dowel pin 216 is also disposed on the first end 212 of the second transition member 204 offset from the opening 214. Also shown in FIG. 2 is a coupling unit 218, engaging the first transition member 202. As will be evident to those skilled in the art, the coupling member 218 is suitably capable of being comprised of a high-density plastic, resistant to breakage. In an alternate embodiment, the coupling member 218 is comprised, for example and without limitation, of a suitable metal, such as steel, aluminum, or the like. The coupling member 218 is illustrated in greater detail in FIG. 5, referred to as a coupling member 500.

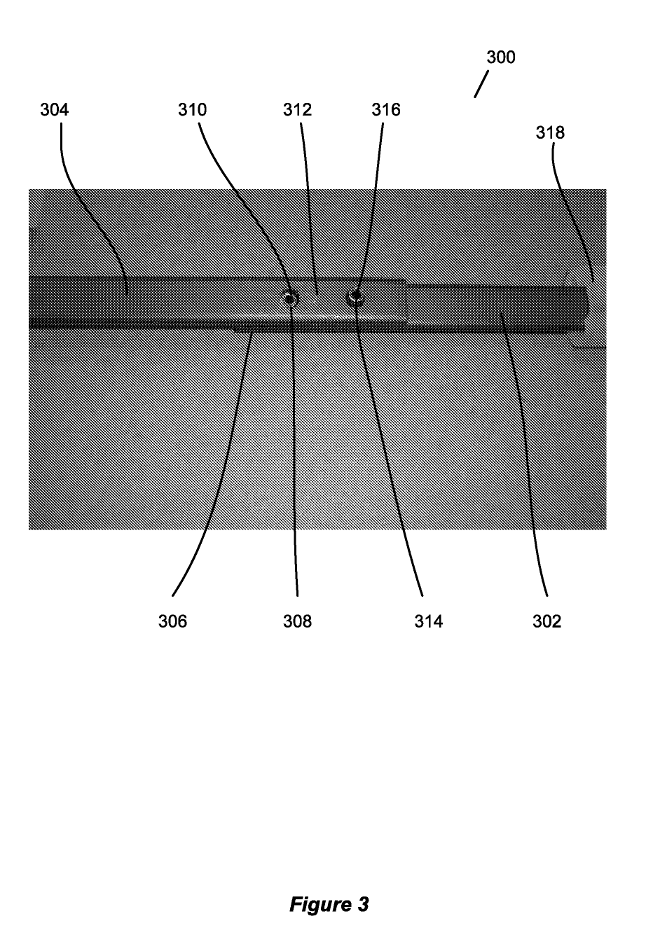

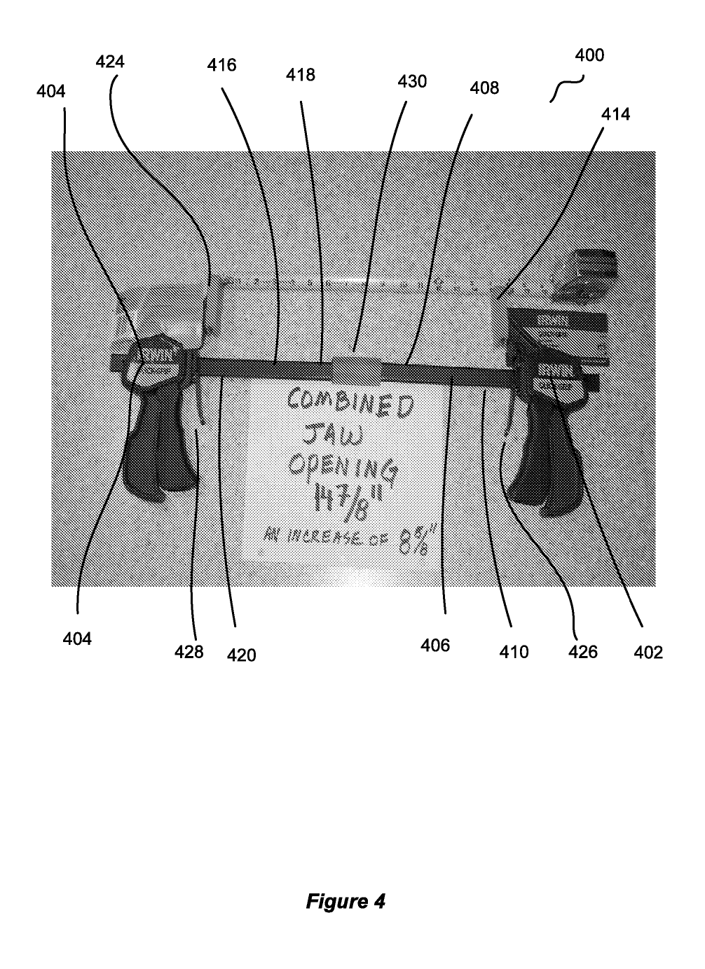

Turning now to FIG. 3, there is shown a side perspective view 300 of the first and second transition members 302, 304 of the adjustable clamp system in an engaged position in accordance with the present invention. As shown in FIG. 3, the first end 306 of the first transition member 302 engages the opening 308 of the second transition member 304 by virtue of the first dowel pin 310. Further, the first end 312 of the second transition member 304 engages the opening 314 of the first transition member 302 by virtue of the second dowel pin 316. Also shown in FIG. 3 is a coupling member 318, engaging the first transition member 302. As will be evident to those skilled in the art, the coupling member 318 suitably corresponds to the coupling member 218 illustrated in FIG. 2. The configuration of the coupling member 318 is advantageously illustrated in FIG. 5 with reference to the coupling member 500.

Turning now to FIG. 4, there is shown a side perspective view of the adjustable clamp system 400 in accordance with the present invention. The adjustable clamp system 400 includes a first clamp member 402 and a second clamp member 404. The first clamp member 402 includes a first transition member 406 having a first end 408 and a second end 410. The first transition member 406 also includes an opening disposed on its first end 408 (not shown in FIG. 4). The first clamp member 402 further includes a first jaw member 414 movably attached to the first transition member 406.

As shown in FIG. 4, the second clamp member 404 includes a second transition member 416 having a first end 418 and a second end 420. The second transition member 416 further includes an opening disposed on its first end 418 (not shown in FIG. 4). The second clamp member 404 further includes a second jaw member 424 movably attached to the second transition member 416. Preferably, the adjustable clamp system 400 of the subject application further includes a first detent member 426 coupled with the first jaw member 414 and a second detent member 428 coupled with the second jaw member 424. As will be appreciated by those skilled in the art, the first detent member 426 and the second detent member 428 are adapted each for maintaining a corresponding jaw member 414, 424 in a given position with respect to a corresponding transition member 406, 416. Also disposed on respective first ends 408, 418 of the first and second transition members 406, 416 are respective dowel pins (not shown in FIG. 4).

As will be recognized by a skilled artisan, the first end 408 of the first transition member 406 engages the opening of the second transition member 416 by virtue of the first dowel pin. Further, the first end 418 of the second transition member 416 engages the opening of the first transition member 406 by virtue of the second dowel pin. The adjustable clamp system 400 of FIG. 4 further includes a coupling member 430 adapted for securing the fixedly engaged first ends of the first and second transition members. Preferably, the coupling member 430 is further adapted for aligning the first and second transition members 406, 416. A skilled artisan will appreciate, that the coupling member 430 is further adapted for enveloping at least partially the engaged first ends 408, 418 of the first and second transition members 406, 416. Preferably, the coupling member 430 includes a cylinder body and will be described with reference to FIG. 5. Those skilled in the art will recognize that the coupling member 430 further provides for stability and alignment of the movable jaws 414, 424, so as to enable the combined adjustable clamp 400 to secure two or more materials, such as wood, plastic, steel, and the like, between the two movable jaws 414, 424.

Turning now to FIG. 5, there is shown a side perspective view of a coupling member 500. The coupling member 500 includes a cylinder body 502. The interior of the cylinder body 502 of the coupling member 500 further includes first and second opposing grooves 504, 506 extending in a direction substantially parallel to the longitudinal axis of the cylinder body 500. The first and second opposing grooves 504, 506 are positioned such that the first and the second dowel pins (not shown in FIG. 5) fit into corresponding first and second opposing grooves 504, 506. Preferably, the interior of the cylinder body 502 of the coupling member 500 further includes third and fourth opposing grooves 508, 510 extending in a direction substantially parallel to the longitudinal axis of the cylinder body 502. Those skilled in the art will recognize, that the third and fourth opposing grooves 508, 510 are positioned such that the engaged first ends of the first and second transition members (not shown in FIG. 5) fit into the interior of the cylinder body 502.

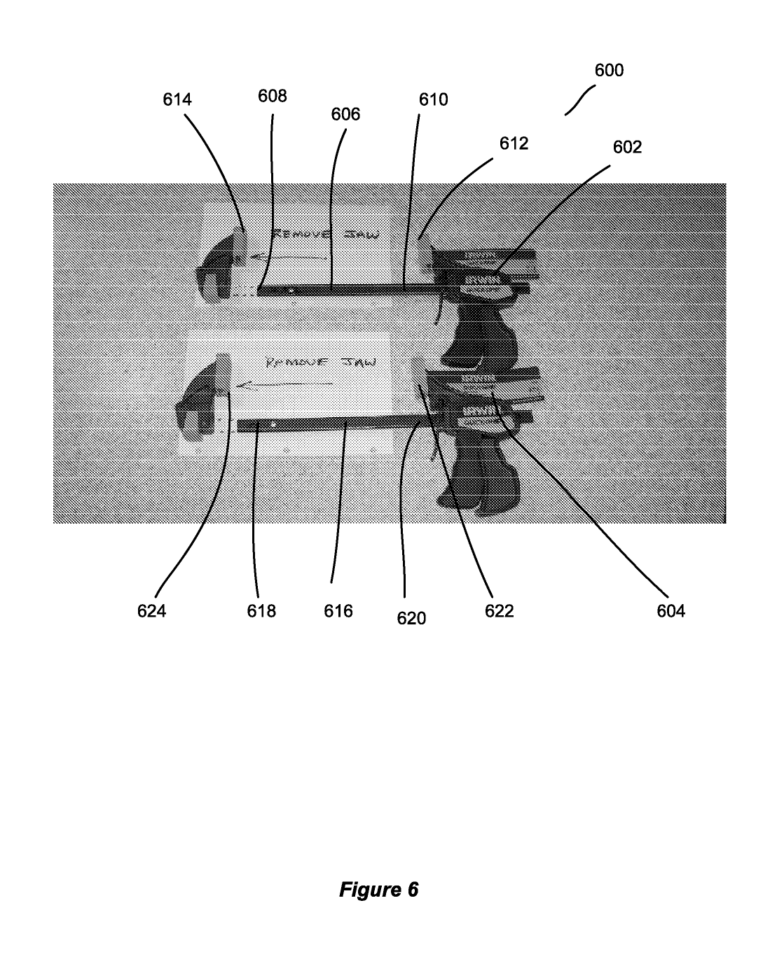

Turning now to FIG. 6, there is shown a side perspective view 600 of two adjustable clamps, namely, of adjustable clamp 602 and adjustable clamp 604. As illustrated in FIG. 6, the adjustable clamp 602 includes a first transition member 606 having a first end 608 and a second end 610. The adjustable clamp 602 also includes a jaw member 612 movably attached to the first transition member 606, and a jaw member 614 fixedly attached to the first end 608 of the first transition member 606.

The adjustable clamp 604 includes a second transition member 616 having a first end 618 and a second end 620. The second adjustable clamp 604 also includes a jaw member 622 movably attached to the second transition member 616, and a jaw member 624 fixedly attached to the first end 618 of the second transition member 616.

In accordance with another aspect of the subject application, the adjustable clamp system includes a third transition member (not shown in the drawings). In this embodiment, the third transition member includes an opening disposed on its first end, and an opening disposed on its second end. In accordance with the subject application, the first end of the first transition member fixedly engages the opening disposed on the first end of the third transition member. In addition, the first end of the second transition member fixedly engages the opening disposed on the second end of the third transition member. As will be recognized by those of ordinary skill in the art, engaging of the first and third transition member, as well as engaging of the second and third transition member, is performed analogous to that described in detail above, with reference to engaging of the first and second transition members.

Turning now to the method for extending a jaw opening of an adjustable clamp in accordance with the present invention, the method will be described with reference to FIG. 3, FIG. 4, FIG. 5, and FIG. 6. The method begins with removing the fixedly attached jaw member 614 from the first transition member 606, and removing the fixedly attached jaw member 624 from the second transition member 616. A coupling member, such as the coupling member 500 shown in FIG. 5, is then engaged with the first transition member 606. As will be recognized by a skilled artisan, the coupling member 500 is slidable with respect to the first transition member 606.

This step is illustrated by FIG. 3, where the coupling member 318 is shown being engaged with the first transition member 302. Next, with respect to FIG. 6, the first end 608 of the first transition member 606 is fixedly engaged with the first end 618 of the second transition member 618. This step is illustrated by FIG. 3, where the first end 306 of the first transition member 302 is shown fixedly engaged with the first end 312 of the second transition member 304. Preferably, as shown in FIG. 3, the dowel pin 308, relieved on the first end 306 of the first transition member 302 subsequent to the removal of the fixedly attached jaw member (which is the jaw member 614 in FIG. 6), is inserted into the opening 310. The opening 310 is relieved on the first end 312 of the second transition member 304 subsequent to the removal of the fixedly attached jaw member (which is the jaw member 624 in FIG. 6). Also, the dowel pin 314, relieved on the first end 312 of the second transition member 304 subsequent to the removal of the fixedly attached jaw member (the jaw member 622 in FIG. 6) is inserted into the opening 318. The opening is relieved on the first end 3306 of the first transition member 302 subsequent to the removal of the fixedly attached jaw member (the jaw member 612 in FIG. 6).

Referring now to FIG. 4, the fixedly engaged first ends 408, 418 of the first and second transition members 406, 416 are then secured, such as encased, by virtue of the coupling member 430. Preferably, the fixedly engaged first ends 408, 418 of the first and second transition members 406, 416 are aligned by means of the coupling member 430. Thus, the jaw opening of the adjustable clamp 400 is formed by the jaw member 414 movably attached to the first transition member 406 and the jaw member 424 movably attached to the second transition member 416. As will be apparent to those skilled in the art, the combined jaw opening formed by the jaw member 414 movably attached to the first transition member 406 and the jaw member 424 movably attached to the second transition member 416, has an increased dimension with respect to the jaw opening of the initial clamp. The latter is illustrated by FIG. 4.

The skilled artisan will further appreciate that the instant example, that of the slide-adjustable clamp, is for illustration purposes, and other adjustable clamps are equally capable of being implemented in accordance with the present invention. For example, and without limitation, a screw-adjusted clamp is equally capable of being adapted in accordance with the present invention so as to increase the jaw opening of the adjustable clamp. Other types of clamps, as will be understood by those skilled in the art, are also capable of employing the present invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. An adjustable clamp system, comprising:
a first clamp member, the first clamp member comprising
a first transition member having a first end and a second end, and including an opening disposed on the first end, and
a first jaw member movably attached to the first transition member; and
a second clamp member, the second clamp member comprising
a second transition member having a first end and a second end, and including an opening disposed on the first end, and
a second jaw member movably attached to the second transition member;
wherein the first end of the first transition member fixedly engages the opening of the second transition member; and
wherein the first end of the second transition member fixedly engages the opening of the first transition member.

2. The adjustable clamp system of claim 1 further comprising:
a first dowel pin disposed on the first end of the first transition member offset from the opening; and
a second dowel pin disposed on the first end of the second transition member offset from the opening;
wherein the first end of the first transition member engages the opening of the second transition member by virtue of the first dowel pin; and
wherein the first end of the second transition member engages the opening of the first transition member by virtue of the second dowel pin.

3. The adjustable clamp system of claim 1 wherein the first transition member and the second transition member are comprised each of a respective slide member, and wherein the first jaw member and the second jaw member are adapted for sliding with respect to a corresponding transition member.

4. The adjustable clamp system of claim 1 wherein the first transition member and the second transition member are comprised each of a respective threaded member, and wherein the first jaw member and the second jaw member include each a corresponding threaded portion, being adapted thereby for being moved along the respective threaded member.

5. The adjustable clamp system of claim 1 further comprising:
a first detent member coupled with the first jaw member; and
a second detent member coupled with the second jaw member;
wherein the first detent member and the second detent member are adapted each for maintaining a corresponding jaw member in a given position with respect to a corresponding transition member.

6. The adjustable clamp system of claim 1 further comprising a coupling member adapted for securing the fixedly engaged first ends of the first and second transition members.

7. The adjustable clamp system of claim 6 wherein the coupling member is further adapted for aligning the first and second transition members.

8. The adjustable clamp system of claim 7 wherein the coupling member is further adapted for enveloping at least partially the engaged first ends of the first and second transition members.

9. The adjustable clamp system of claim 8 wherein the coupling member includes a cylinder body.

10. The adjustable clamp system of claim 9 wherein the interior of the cylinder body of the coupling member further includes a first and second opposing grooves extending in a direction substantially parallel to the longitudinal axis of the cylinder body such that the first and second dowel pins fit into corresponding first and second opposing grooves.

11. The adjustable clamp system of claim 9 wherein the interior of the cylinder body of the coupling member further includes a third and fourth opposing grooves extending in a direction substantially parallel to the longitudinal axis of the cylinder body such that the engaged first ends of the first and second transition members fit into the interior of the cylinder body.

12. An adjustable clamp system, comprising:
a first clamp member, the first clamp member comprising
a first transition member having a first end and a second end, and including an opening disposed on the first end, and
a first jaw member movably attached to the first transition member;
a second clamp member, the second clamp member comprising
a second transition member having a first end and a second end, and including an opening disposed on the first end, and
a second jaw member movably attached to the second transition member; and
a third transition member having a first end and a second end, the third transition member including an opening disposed on the first end, and an opening disposed on the second end;
wherein the first end of the first transition member fixedly engages the opening disposed on the first end of the third transition member; and
wherein the first end of the second transition member fixedly engages the opening disposed on the second end of the third transition member.

13. The adjustable clamp system of claim 12 further comprising:
a first dowel pin disposed on the first end of the first transition member offset from the respective opening; and
a second dowel pin disposed on the first end of the second transition member offset from the respective opening;
wherein the first end of the first transition member engages the opening disposed on the first end of the third transition member by virtue of the first dowel pin; and
wherein the first end of the second transition member engages the opening disposed on the second end of the third transition member by virtue of the second dowel pin.

14. The adjustable clamp system of claim 13 further comprising:
a third dowel pin disposed on the first end of the third transition member offset from the respective opening disposed on the first end; and
a fourth dowel pin disposed on the second end of the third transition member offset from the respective opening disposed on the second end;
wherein the first end of the third transition member engages the opening disposed on the first end of the first transition member by virtue of the third dowel pin; and
wherein the second end of the third transition member engages the opening disposed on the first end of the second transition member by virtue of the fourth dowel pin.

15. The adjustable clamp system of claim 12 further comprising:
a first coupling member; and
a second coupling member;
wherein the first coupling member is adapted for securing the fixedly engaged first end of the first transition member and first end of the third transition member; and
wherein the second coupling member is adapted for securing the fixedly engaged first end of the second transition member and second end of the third transition member.

16. The adjustable clamp system of claim 15 wherein the first coupling member is further adapted for aligning the first and third transition members; and wherein the second coupling member is further adapted for aligning the second and third transition members.

17. The adjustable clamp system of claim 16 wherein the first coupling member is further adapted for enveloping at least partially the engaged first end of the first transition member and first end of the third transition member; and wherein the second coupling member is further adapted for enveloping at least partially the engaged

18. A method for extending a jaw opening of an adjustable clamp, the adjustable clamp including a first transition member, the first transition member having a first end and a second end, a jaw member movably attached to the first transition member, and a jaw member fixedly attached to the first end of the first transition member, comprising the steps of:
removing the fixedly attached jaw member from the first transition member;
removing a fixedly attached jaw member from a second transition member, the second transition member being part to another adjustable clamp, the second transition member having a first end and a second end, the other adjustable clamp further including a jaw member movably attached to the second transition member, the fixedly attached jaw member being attached to the first end of the second transition member;
engaging a coupling member with the first transition member, the coupling member being slidable with respect to the first transition member;
fixedly engaging the first end of the first transition member with the first end of the second transition member; and
securing the fixedly engaged first ends of the first and second transition members by virtue of the coupling member;
wherein the jaw opening of the adjustable clamp is thereby formed by the jaw member movably attached to the first transition member and the jaw member movably attached to the second transition member.

19. The method of claim 18 wherein the step of fixedly engaging further comprises:
inserting a dowel pin, relieved on the first end of the first transition member subsequent to the removal of the fixedly attached jaw member, into an opening, relieved on the first end of the second transition member subsequent to the removal of the fixedly attached jaw member; and
inserting a dowel pin, relieved on the first end of the second transition member subsequent to the removal of the fixedly attached jaw member, into an opening, relieved on the first end of the first transition member subsequent to the removal of the fixedly attached jaw member.

20. The method of claim 18 wherein the step of securing further comprises the step of aligning the fixedly engaged first ends of the first and second transition members.
